(19) United States
(12) Patent Application Publication
(10) Pub. No.: US 2017/0017298 A1
(43) Pub. Date: Jan. 19, 2017

(54) REAL TIME CONTROL OF VOLTAGE STABILITY OF POWER SYSTEMS AT THE TRANSMISSION LEVEL

(71) Applicants: Saugata Swapan Biswas, Kirkland, WA (US); Anurag Kumar Srivastava, Pullman, WA (US)

(72) Inventors: Saugata Swapan Biswas, Kirkland, WA (US); Anurag Kumar Srivastava, Pullman, WA (US)

(73) Assignee: WASHINGTON STATE UNIVERSITY, Pullman, WA (US)

(21) Appl. No.: 14/800,539

(22) Filed: Jul. 15, 2015

(51) Int. Cl. G06F 1/32; G06F 13/36

(52) U.S. Cl. CPC G06F 1/3296; G06F 13/36

(57) ABSTRACT

The embodiments provide for a method and system of automated online control of a power system's voltage stability or even provide quick suggestions for fast decision support to the system operators to ensure a desired voltage stable system when needed. An example embodiment includes estimating data representing system parameters of a power system; non-iteratively determining a voltage stability index for each bus in the power system based on the estimated and received data sets; monitoring the voltage stability index for each bus so as to compare a computed voltage stability index for each bus to a predetermined voltage stability index threshold; and activating a voltage stability control mode resultant from the comparison of the computed voltage stability index for each bus to the predetermined voltage stability index threshold, wherein the voltage stability control mode is selected from: a normal mode of operation and an emergency mode of operation.

### GOVERNMENT INTERESTS

This work was partially funded by Power Systems Engineering Research Center (PSERC) under grant 14N-3820-5286. The government has certain rights in the invention.

### BACKGROUND OF THE INVENTION

1. Field of the Invention

The present embodiments herein relate to the field of voltage stability control methods and systems, and more particularly, to a system and a method for enhancing voltage stability control capabilities for power systems.

2. Discussion of the Related Art

Voltage stability studies have been investigated by researchers in the past as several blackouts have been caused or accompanied by voltage instability phenomenon. However, with the advent of synchrophasor technology, as wide area system information is available in real time in the form of voltage and current phasors, improved algorithms can be developed that can make optimum utilization of this bank of system information to efficiently monitor the voltage stability status of the power system. This in turn can enable the generation of quick and appropriate control actions so as to avert a voltage unstable situation that can possibly lead to a blackout.

Due to this reason, some voltage stability monitoring and control algorithms have been developed in the last few years in industries and academics that aim at making use of the measurements available from the synchrophasor and supervisory control and data acquisition (SCADA) technologies. From literature review on this subject, it has been seen that, the voltage stability control algorithms can be broadly classified based on the following approaches: A. Centralized (Wide Area) Control Approach and B. Decentralized (Local) Control Approach.

The algorithms based on a ‘Centralized (Wide Area) Control Approach’ are generally based on optimal power flow and are computationally intensive and not particularly suitable for online or fast voltage stability control. Also, these algorithms get feedback mostly from pilot buses in the zones in the monitored system in the form of voltage magnitudes and not voltage stability margin. Also, choosing the right pilot buses may be very challenging, and even the selected pilot bus voltages may still not be able to reflect the zonal or regional voltage stability status correctly. On the other hand, control algorithms based on ‘Decentralized (Local) Control Approach’ are generally based on simple logic, for instance, it is a rule-based approach that takes into account voltage magnitude, time, and/or rate of change of voltage magnitude at the monitored bus. However, it has been well established that these parameters may not be the correct or sufficient indicators of voltage stability in all the possible conditions. Hence the control actions taken based on such algorithms might not be the best actions to improve the voltage stability at the system level. These algorithms cannot integrate wide area coordinated control actions as they do not have the system level information. This restricts the possibility of improvement in voltage stability once the local resources are all exhausted.

Now with the power grid gradually becoming “smarter,” there is a need in the industry for developing a new voltage stability control tool that is able to monitor the wide area voltage stability condition of a power system and then take fast and suitable wide area coordinated control actions in real time by eliminating the above mentioned limitations of both the approaches to avoid a possible voltage collapse. This kind of monitoring and control tool can be a very useful contribution to the power industries and utilities, as this allows efficient monitoring and automated online control of the power system voltage stability or provide quick suggestions for fast decision support to the system operators to ensure a desired voltage stable system, when needed. The embodiments presented herein are directed to such a need.

### SUMMARY OF THE INVENTION

It is to be appreciated that the present example embodiments herein are directed a method for real time control of voltage stability in a power system including, with a logic processor device: estimating system parameters based on one or more received data sets of system parameters of a power system, wherein the one or more received data sets of system parameters further comprises at least one of: a voltage magnitude and a voltage angle and breaker ON/OFF status of switch at each bus in the power system; non-iteratively determining a voltage stability index for each bus in the power system based on the estimated system parameters and the received one or more data sets of system parameters; comparing the determined voltage stability index for each bus to a predetermined voltage stability index threshold; and activating a voltage stability control mode resultant from the comparison of the computed voltage stability index for each bus to the predetermined voltage stability index threshold, wherein activating a voltage stability control mode includes at least one mode selected from: a normal voltage stability control mode of operation and an emergency voltage stability control mode of operation of operation.

According to another aspect of the present application, a real time voltage stability index computing system is provided of which includes: a logic processor device; a memory operatively coupled to the processor, the memory containing instructions that when executed by the processor cause the logic processor device to perform a process including: estimating system parameters based on one or more received data sets of system parameters of a power system, wherein the one or more received data sets of system parameters further comprises at least one of: a voltage magnitude and a voltage angle and breaker ON/OFF status at each bus in the power system; non-iteratively determining a voltage stability index for each bus in the power system based on the estimated system parameters and the received one or more data sets of system parameters; comparing the determined voltage stability index for each bus to a predetermined voltage stability index threshold; and activating a voltage stability control mode resultant from the comparison of the computed voltage stability index for each bus to the predetermined voltage stability index threshold, wherein activating a voltage stability control mode includes at least one mode selected from: a normal voltage stability control mode of operation and an emergency voltage stability control mode of operation of operation.

### BRIEF DESCRIPTION OF THE DRAWINGS

FIG. 1 shows an example schematic diagram of a power system that can utilize the Real Time Voltage Stability Monitoring and Control (RT-VSMAC) tool embodiments of the present technology.

FIG. 2 shows a general functional flowchart of the RT-VSMAC tool disclosed herein.

FIG. 3 shows an example flowchart of the normal mode of the voltage stability controller in the RT-VSMAC tool.

FIG. 4 shows an example flowchart of the emergency mode of the voltage stability controller in the RT-VSMAC Tool.

FIG. 5A shows plots of the variation of critical metrics of all load buses before & after control. In particular, FIG. 5A shows the critical parameters (due to sequence of events disclose in Table-3 herein) and is then being controlled by the RT-VSMAC Tool (in the form of the control actions disclosed in Table-4 herein).

FIG. 5B also shows plots of the variation of critical metrics of all load buses before & after control. In particular, FIG. 5B also shows the critical parameters (voltage magnitude & angle) and with the VSAI of all load buses in the test power system, starting from the base case till it gets stressed (due to sequence of events mentioned in Table-5) and is then being controlled by the RT-VSMAC Tool (in the form of the control actions listed in Table-6).

### DETAILED DESCRIPTION

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. It is to be noted that as used herein, the term “adjacent” does not require immediate adjacency. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise.

In addition, unless otherwise indicated, numbers expressing quantities of ingredients, constituents, reaction conditions and so forth used in the specification and claims are to be understood as being modified by the term “about.” Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

### Specific Description

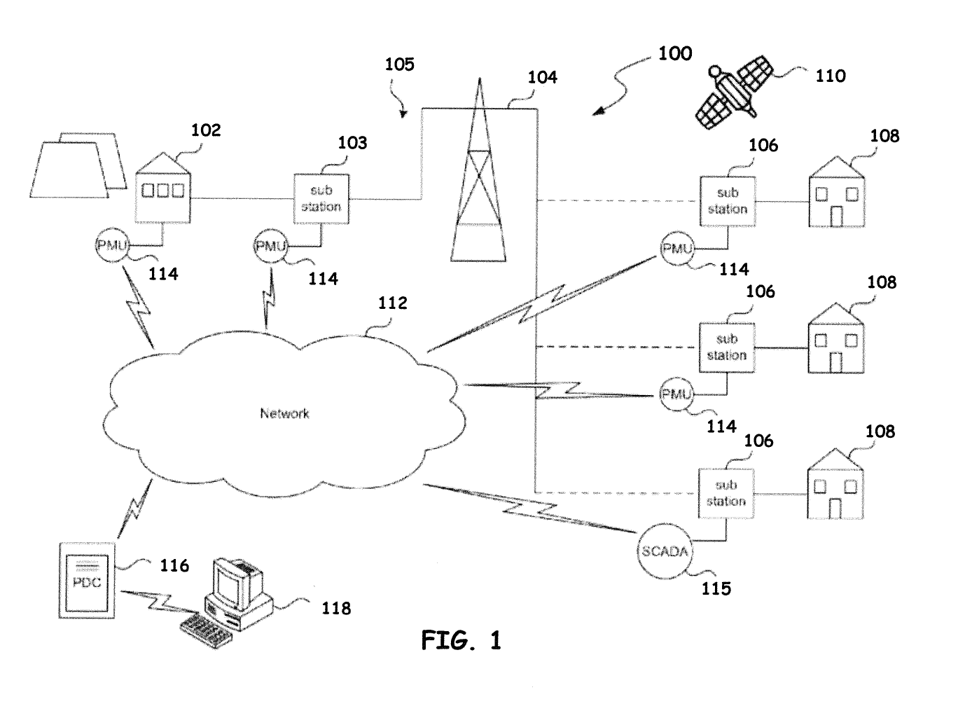

Turning now the drawings, FIG. 1 is a schematic diagram of a power system 100 in accordance with embodiments of the technology. As part of the method of operation to be utilized by the control methods disclosed herein, system parameters (e.g., voltage, power, phase, etc.) of different nodes in the power system are collected at one time instant and derived network parameters can then be used to calculate a voltage stability index (VSAI) of the power system. Such a method of operation of collecting the system parameters to be utilized in systems, such as that shown FIG. 1, is discussed in detail in U.S. Published Application No. 2014/0244065, to Biswas et al., entitled: “Voltage Stability Monitoring in Power Systems,” the disclosure of which is incorporated herein in its entirety.

In general, U.S. Published Application No. 2014/0244065 discloses novel systems and methods for deriving voltage stability indices (VSAI) in a non-iterative manner based on both (1) at least one set of system parameters collected at one instance (referred to herein as “actual system parameters”); and (2) topology information of a power system, such as the power system shown in FIG. 1. The actual system parameters often can include one or more of a voltage, voltage angle, current, current angle, bus connectivity status (e.g., as represented by a bus admittance matrix), predicted real power load, predicted reactive power load, predicted bus connective status, and/or other suitable types of data from phasor measurement units (“PMUs” or synchrophasors), supervisory control and data acquisition (“SCADA”) facilities, and/or other suitable sensors of the power system. The topology information can include inter-node connectivity data, intra-node connectivity data, and/or other suitable data.

FIG. 1 thus illustrates a schematic diagram of a power system 100 to be integrated with the novel wide area voltage stability control algorithm Real Time Voltage Stability Monitoring and Adaptive Control (RT-VSMAC) Tool, as disclosed herein. FIG. 1 in general includes a power generating plant 102, a step-up substation 103, a transmission tower 104, a plurality of step-down substations 106, and a plurality of power consuming loads 108 interconnected with one another by a power grid 105. Even though only certain system components (e.g., one power generating plant 102 and one step-up substation 103) are illustrated in FIG. 1, in other embodiments, the power system 100 and/or the power grid 105 can include other system components in addition to or in lieu of those components shown in FIG. 1.

The power system 100 can also include a plurality of phasor measurement units (“PMUs” or synchrophasors) PMUs 114 and/or supervisory control and data acquisition (“SCADA”) facilities 115, and/or other suitable sensors individually coupled to various system components of the power system 100. For example, as illustrated in FIG. 1, the power generating plant 102, the step-up substation 103, and two of the step-down substations 106 include PMUs 114. The other step-down substation 106 includes a SCADA device 115. The SCADA device 115 can be configured to measure voltage, current, power, and/or other suitable parameters. The PMUs 114 can be configured to measure voltage, current, voltage phase, current phase, and/or other types of phasor data in the power system 100 based on a common time reference (e.g., a GPS satellite 110).

The power system 100 can also include a phasor data concentrator (“PDC”) 116 operatively coupled to the PMUs 114 via a network 112 (e.g., an internet, an intranet, a wide area network, and/or other suitable types of network). The PDC 116 can be configured to receive and process data from the PMUs 114 and the SCADA device 115 to generate actual system parameters. For example, in certain embodiments, the PDC 116 can include a logic processing device (e.g., a network server, a personal computer, etc.) located in a control center and configured to receive and “align” phasor measurements from the PMUs 114 based on corresponding time stamps with reference to the GPS satellite 110. In other embodiments, the PDC 116 can also be configured to receive and compile data received from the SCADA device 115. The PDC 116 can then store and/or provide the actual system parameters for further processing by other components of the power system 100.

In the illustrated embodiment, the power system 100 includes a supervisory computing station 118 operatively coupled to the PDC 116. The supervisory computing station 118 can include a network server, a desktop computer, and/or other suitable computing devices of various circuitry of a known type, such as, but not limited to, by any one of or a combination of general or special-purpose processors (digital signal processor (DSP)), firmware, software, and/or hardware circuitry to provide instrument control, data analysis, etc., for the example configurations disclosed herein.

It is to be noted that in using such example computing devices, it is to also to be appreciated that as disclosed herein, the incorporated individual software modules, components, and routines may be a computer program, procedure, or process written as source code in C, C#, C++, Java, and/or other suitable programming languages. The computer programs, procedures, or processes may be compiled into intermediate, object or machine code and presented for execution by any of the example suitable computing devices discussed above. Various implementations of the source, intermediate, and/or object code and associated data may be stored in one or more computer readable storage media that include read-only memory, random-access memory, magnetic disk storage media, optical storage media, flash memory devices, and/or other suitable media. A computer-readable medium, in accordance with aspects of the present invention, refers to media known and understood by those of ordinary skill in the art, which have encoded information provided in a form that can be read (i.e., scanned/sensed) by a machine/computer/processor and interpreted by the machine's/computer's/processor's hardware and/or software. It is also to be appreciated that as used herein, the term “computer readable storage medium” excludes propagated signals, per se.

Turning back to FIG. 1, the supervisory computing station 118 is configured to retrieve data related to the system parameters from the PDC 116 and analyze the retrieved data in order to monitor voltage stability in the power system 100. In other embodiments, the supervisory computing station 118 may be omitted, and the PDC 116 and/or other suitable computing devices (not shown) may perform at least some of the operations described below.

In operation, the PDC 116 receives measurement data from the PMUs 114 and the SCADA device(s) 115 individually associated with various components of the power system 100. The PDC 116 can then compile and/or otherwise process the received measurement data to generate data related of the actual system parameters. For example, in one embodiment, the PDC 116 can “align” phasor measurements from the PMUs 114 based on corresponding time stamps with reference to the GPS satellite 110. In other embodiments, the PDC 116 can also sort, filter, average, and/or perform other operations on the received data.

The PDC 116 can then provide at least one set of the generated actual system parameters at one instance to the supervisory computing station 118 for analysis of voltage stability. The supervisory computing station 118 then derives one or more voltage stability indices in a non-iterative manner based on both (1) the at least one set of actual system parameters received from the PDC 116; and (2) topology information of the power system 100. The supervisory computing station 118 can then raise an alarm, outputting a warning signal, and/or perform other suitable actions based on the derived voltage stability indices. In certain embodiments, the supervisory computing station 118 can also predict or estimate one or more voltage stability indices based on expected and/or historical load conditions in the power system 100.

Several embodiments presented herein can more accurately determine or estimate the voltage stability indices because the present technology does not require data collected over a window of time. Rather, only one set of actual system parameters may be needed to derive a voltage stability index. Thus, fluctuation in conditions of the power system 100 does not significantly impact the derived voltage stability index. Also, the present technology utilizes calculations in a non-iterative manner without needing multiple sets of the actual system parameters. Thus, the present technology can more efficiently derive the voltage stability indices that can be provided to the novel control algorithms herein via a state estimator (SE) module (not shown in FIG. 1), as discussed below.

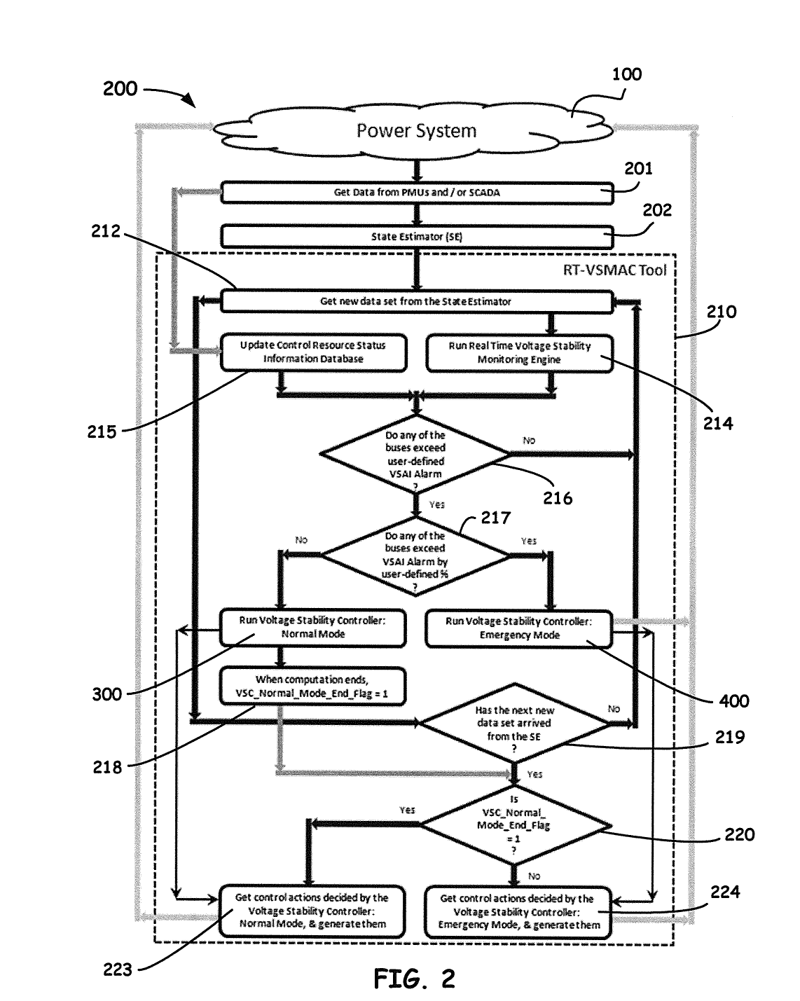

FIG. 2 thus shows a functional flowchart of the RT-VSMAC Tool, generally designated by the reference numeral 200. As shown in FIG. 2, a state estimator 202 (e.g., a state estimator module) can be configured to perform state estimation based on system parameters. As an illustration, the state estimator 202, present at the control center, e.g., the supervisory computing station 118 of FIG. 1, gets raw data from syncrophasor devices, such as the PMU's and SCADA 201 (see PMUs 114 and/or SCADA devices 115 in FIG. 1) shown configured with example transmission level substations 106, as also shown in FIG. 1. As used herein, a state as being related to the power system 100 of FIG. 1, and as detailed in incorporated by reference U.S. Published Application No. 2014/0244065, generally refers to a complex voltage with a voltage magnitude and a phase angle at each bus in the power system 100.

In particular, a state estimation generally refers to estimate and/or infer the state based on available measurements of system parameters. For example, in one embodiment, the state estimator 202 shown in FIG. 2 may be configured to perform a linear state estimation based on phasor measurements from the PMUs 114 of FIG. 1 or may be alternately configured to perform a hybrid state estimation based on data collected from both the PMUs 114 and the SCADA device 115 shown in FIG. 1.

As another example arrangement, the state estimator 202 shown in FIG. 2 may be configured to perform a state estimation based on data collected from the SCADA device 115 alone, for example, by calculating the phase angle based on collected real and reactive power from SCADA device 115. In other embodiments, the state estimator 202 may be configured to perform state estimation based on other suitable information and/or in other suitable manners. In further embodiments, the state estimator 202 shown in FIG. 2 may be omitted, and the PDC 116 shown in FIG. 1 may perform the state estimation. In any configuration, values of voltage magnitude, voltage angle and/or other suitable parameters for all buses in a power system 100 are capable of being obtained.

Accordingly, the novel RT-VSMAC tool 210 (also as denoted within the dashed box), as described herein, is beneficially and in a novel manner integrated into existing infrastructure at a power control center, e.g., the supervisory computing station 118 of FIG. 1, as it receives data often but not necessarily, from the state estimator 202. The novel RT-VSMAC tool 210 shown in FIG. 2 is thus configured to receive voltage measurements and breaker ON/OFF status data collected from the power system using SCADA and/or synchrophasor technology of which is fed to the State Estimator (SE) 202 in the control center, as exemplified in incorporated by reference U.S. Published Application No. 2014/0244065. In particular, the RT-VSMAC Tool 210 gets its input data from the State Estimator (SE) output 202 so as to be received as one or more new data sets from the State Estimator (SE) 212, as generally shown in FIG. 2. It is to be noted that using a SCADA data based SE often makes the process of acquiring input data slower, while using a PMU data based SE can make this process faster, thus resulting in faster monitoring and control. As another example arrangement, suitable dead/delay time may be added by the system operator (based on requirements/preference) before the RT-VSMAC Tool 210 can start operating. The RT-VSMAC Tool 210 shown in FIG. 2 often, but not necessarily, includes the following major modules:
Module 1: Real Time Voltage Stability Monitoring module 214: for detection of any voltage stability problems in a system.
Module 2: Control Resource Status Information Database module 215: for real time archival of status control resources in the system.
Module 3: Comprises two sub-module parts: a Voltage Stability Controller Module operating in the Normal Mode 300 and a Voltage Stability Controller Module operating in the Emergency Mode 400): wherein each of the sub-modules is configured for planning appropriate control action(s) to mitigate voltage stability problems.
Module 4: Also comprises two sub-module parts: a Control Actions Generator Module for the Normal Mode 223 and a Control Actions Generator Module for the Emergency Mode 224): wherein each of the sub-modules is configured for actual generation of planned controlled actions as decided in the sub-modules of Voltage Stability Controller Normal Mode 300 and Emergency Mode 400 modules.

Turning to FIG. 2, the Real Time Voltage Stability Monitoring (engine) module 214, i.e., Module 1, computes the ‘Voltage Stability Assessment Index (VSAT)’ in a substantially non-iteratively, more often in a completely non-iterative manner, for an entire power system 100, every time a new set of measurement data is obtained from the state estimator (SE) 202. The VSAI computation is done in substantially the same way as the “RT-VSM Tool” 210, as described in incorporated by reference U.S. Published Application No. 2014/0244065. In particular, if the VSAI value at a load bus is close to ‘0’, it indicates that the load bus is highly voltage stable. On the other hand, if the VSAI is close to ‘1’, it indicates that the load bus is near the point of voltage collapse. The system VSAI is given by the VSAT of the weakest bus in the system, i.e., the bus with the highest VSAI. The control actions provided by Module 3, i.e., the Voltage Stability Controller Normal Mode 300 and emergency Mode 400 modules, get activated if the Real Time Voltage Stability Monitoring module 214 gives an alarm that one or more buses in the system has exceeded the threshold VSAI. On getting activated, the Control Resource Status Information Database module 215 (Module 2) finds different control actions for increasing the voltage stability status of all the weak buses simultaneously. This is also based on the availability of the controllers in the system whose real time status information is available from Control Resource Status Information Database module 215.

The Control Status Information Database module 215 thus archives the real time status information of the different control devices/equipment available in the monitored system (e.g., raw data from syncrophasor devices, such as the PMU's and SCADA 201, as shown in FIG. 1) for the purpose of voltage stability control and/or the choice of the user. This includes the status of:

Line switching availability

Transformer automatic load tap changer blocking availability

Shunt reactive power compensation availability

Series reactive power compensation availability

Generator and synchronous condenser reactive power control availability

Load priority for load-shedding schemes

Based on the status information of the above mentioned devices/equipment, the RT-VSMAC Tool 200 is configured to strategize their coordination for wide area voltage stability control. As a non-limiting example of strategizing, a determination is necessarily made by decision block 216, as shown in FIG. 2 based on the VSAI computational result provided by the real time voltage stability module 214 as well as the status information provided by the Control Status Information Database module 215. The threshold may be set by an operator based on historical values and/or otherwise determined. If it is determined that none of the bus or buses is/are above the user-defined VSAI alarm threshold 216 (No), as shown in FIG. 2, then a new data set 212 is requested to be provided by the State Estimator (SE) 202. The decision stage 219 determines if the new data set has arrived from the State Estimator (SE) 202 and if not, it reverts back to requesting a new data set at stage 212. If it has received a new data set, then the example method of FIG. 2 optionally decides to indicate to the decision stage at 220 that the new data set has arrived for determination of whether the computational mode for the Normal mode Run Voltage stability controller 300 has ended, as discussed below.

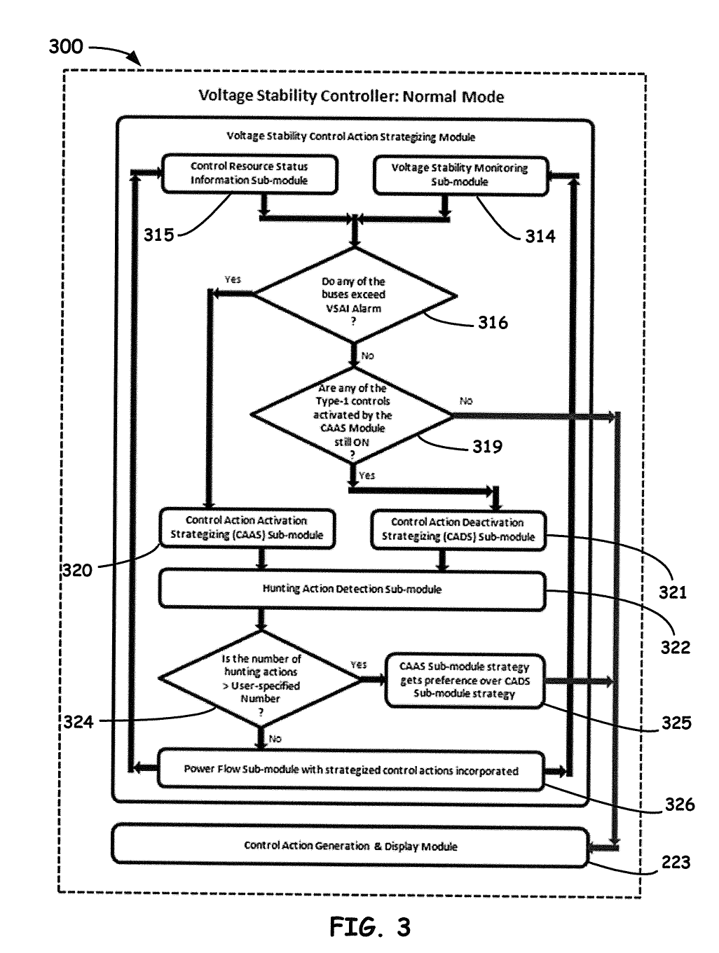

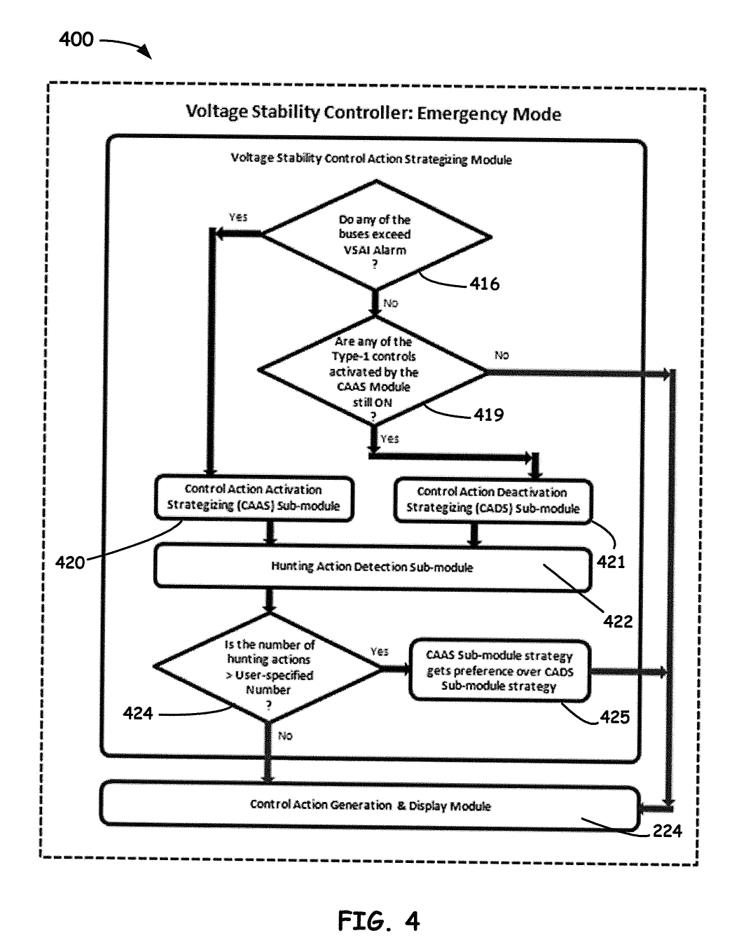

If it is determined that any bus or buses is/are found to have exceeded a user-defined VSAI alarm threshold decision stage 216 (Yes), as also shown in FIG. 2, then these one or more buses are designated as weak buses and are stored in a memory location, which in turn can activate, as shown by decision block 217 in FIG. 2, the Normal mode Run Voltage stability controller 300 (No, if below the VSAI alarm threshold by a certain user-defined margin) or the Emergency Mode Run Voltage stability controller 400 (YES, if above the VSAI alarm threshold by a certain user-defined margin), as explained in more detail below with reference to FIG. 3 and FIG. 4 respectively.

It is also to be noted that FIG. 2 also shows that when the computational mode for the Normal mode Run Voltage stability controller 300 ends, a Flag=1 at stage 218 is resultant to be provided to decision stage 220. If the Normal Mode end flag is =1, then Control Actions decided by the Voltage Stability Controller 300 are requested at stage 223. If not equal to 1, the method shown in FIG. 2 can include requesting Control Actions by the Voltage stability controller emergency Mode 400 at stage 224. Decided control actions by either module 223 or module 224 (collectively Module 4 described above) are then capable of being fed back to the power system 100.

### Voltage Stability Controller—Normal Mode:

FIG. 3 thus shows an example non-limiting flowchart of the Voltage Stability Controller Normal Strategizing Mode 300 of operation, as exemplified in the RT-VSMAC Tool 210 of FIG. 2. The aim is to generate a minimum set of control actions to improve the voltage stability of the power system 100. Accordingly, input from the Voltage Stability Monitoring Sub-module 314 and the Control Resource Status Information Sub-module 315 are provided to a decision stage 316.

It is to be appreciated that if the Real Time Voltage Stability Monitoring Engine detects one or more buses violating the set VSAI alarm limit as indicated at the decision stage 316 by the operator, then the normal mode 300 internally strategizes at the Control Action Activation Strategizing (CAAS) Sub-module 320, the different types of coordinated wide area control actions and estimates their effects at each internal stage using an internal voltage stability estimation engine. While performing the control strategies at each internal stage, this mode takes into account the coordinated decisions made by the Control Action Activation Strategizing (CAAS) Sub-module 320 and/or Control Action Deactivation Strategizing (CADS) Sub-module 321 along with the Hunting Action Detection (HAD) Sub-module 322.

The Control Action Activation Strategizing (CAAS) Sub-module 320 aims at strategizing the activation of coordinated control actions at each internal stage involving individual control actions blocks that may include, but not strictly limited to:

Type-1 Control Actions Block (for positive compensation)

Line switching: When system loading is very low and the system is quite secured, power system operators may choose to disconnect a few lines in the network to avoid overvoltage problems. However, if due to some sudden contingency (or contingencies), the system is weakened from voltage stability perspective, some of these disconnected lines may need to be reconnected to stabilize the system by reducing the stress in transmission.

Transformer automatic load tap changer (ALTC) blocking: Automatic Load Tap Changers (ALTC) are transformers that connect the transmission or sub-transmission systems to the distribution systems. They are typically equipped with regulation capability that allow them to automatically control the voltage on the low side so that voltage deviation on the high side is not seen on the low side. When the voltage on the high voltage (HV) side (i.e. transmission side) decreases, the low voltage (LV) side voltage also starts declining, and the ALTC automatically starts operating to change the tap positions on the LV side to raise the LV side voltage. This results in decrease of current on the LV side and an increase in the reactive component of current on the HV side. Thus from the transmission side it seems as if the reactive power consumption of load has increased (due to increase in reactive component of current on the HV side of the transformer), thus stressing the system even more than before the ALTC had operated. The present embodiments herein are configured to stop this kind of a detrimental effect by blocking the ALTC when such an event occurs. This beneficially prevents deterioration of the system from a voltage stability perspective.

Shunt reactive power compensation: As the underlying reason for weakening of voltage stability in a system is the imbalance of demand and supply of reactive power, hence one way to compensate this deficiency in supply of reactive power is to provide extra reactive power locally at the locations where there is a deficit in reactive power. In the online voltage stability control algorithm configured herein, discrete shunt reactive power compensators in the form of fixed shunt capacitor banks have been taken into account. While Flexible Alternating Current Transmission Systems (FACTS) having controlled continuous shunt reactive power compensators can be incorporated by the embodiments herein, such systems are not usually desirable as they typically very expensive (about 5-6 times more than fixed shunt capacitor banks) and are still not used in large numbers in present day power systems.

Series reactive power compensation: The maximum power that can be transferred through a line plays a vital role in determining the voltage stability margin. In turn, this maximum power transfer capability of a line depends inversely on the reactance of the line. Thus, to increase the maximum power transfer through a line, the latter's reactance needs to be decreased, which is possible using series capacitors. Switching in series capacitors in the lines reduce the net reactance of the line, thereby increasing the maximum power flow through it, and thus improving the voltage stability margin. The embodiments herein are capable of using such series capacitors.

Generator and synchronous condenser reactive power control: The embodiments herein can additional utilize this way of increasing the reactive power supply to meet the increased demand of reactive power by a system described by the present application. The generators and synchronous condensers form the dynamic reserves of reactive power in a power system. When a synchronous generator pushes reactive power into the electrical system, the machine is said to be over-excited. However, when the synchronous generator absorbs reactive power from the electrical system, it is said to be under-excited. The reactive power output of the generator is associated with the generator field current, provided by the excitation system. Thus, due to physical limits of the excitation system, the generators have a maximum and minimum reactive power capability, beyond which they cannot supply or absorb reactive power respectively. Generators are usually operated using the AVR (automatic voltage regulator) in constant voltage mode, and reactive power injection (positive or negative) is automatically a result of the AVR operation. In the embodiments herein, if any emergency condition of system stress arises that can't be countered using line switching, or discrete shunt and series reactive power compensation, and more reactive power is required to improve system voltage stability, the generators are operated in constant reactive power mode i.e. the generator bus is made to behave as a load bus with positive injection (i.e. negative load). The reactive power is generated as per the generator capability curves, until the generators reach their reactive power limits.

Type-2 Control Actions Block (for negative compensation)

Controlled Load-shedding: This is the last resort for voltage stability control, when all Type-1 control actions (as discussed above) have been unsuccessful in bringing the system voltage stability to the desired level. If reactive power supply cannot be increased by more than a certain extent, the only option left to bring back the balance between reactive power demand and supply is to curtail the reactive power demand through controlled load shedding. Thus, in the novel control algorithm embodiments as disclosed herein, the loads connected to each bus in the system have been categorized as priority and non-priority loads. While priority loads are not shed at any time, the non-priority loads are shed starting with higher quantities of load followed by lower quantities in each subsequent step. Load shedding of the non-priority loads is performed maintaining the same power factor as the one before any load shedding was performed.

Turning back to FIG. 3, The RT-VSMAC Tool offers high flexibility to operators in the form of activation/deactivation of any of the above control blocks based on their preferences or availability of system control resources. The control actions strategized by the CAAS Sub-module are fed to the Power Flow Sub-module to predict the effect of such control actions. This iterative process continues until all the weak buses have been taken care of. The CADS Sub-module aims at deactivating the excess control actions in the Type-1 category, as discussed above, that have been previously activated by the CAAS Sub-module, thus ensuring that efficient use of system control resources are made at all times. This has been discussed and indicated by decision block 316 (216 in FIG. 2), then a decision at stage 319 is made to decide if any Type-1 controls are still on. If any Type-1 controls are not on, then this is displayed via module 223. If Type-1 controls are still on, then the Control Action Deactivation Strategizing (CADS) Sub-module 321 is enabled with its output provided to the Hunting Action Detection (HAD) Sub-module 322.

There may arise situations when the CAAS Sub-module 320 and CADS Sub-module 321 contradict each other, resulting in hunting between their actions. The operator is thus capable of being asked to enter a maximum number of hunting actions to be specified, as shown by decision block 324 in FIG. 3, and of which is to be displayed by module 223. These types of situations are called “hunting” because the Hunting Action Detection (HAD) Sub-module 322 algorithm starts hunting (given the input by the user to be utilized by decision block 324) between the Control Action Activation Strategizing CAAS Sub-module 320 strategy and the Control Action Deactivation Strategizing CADS Sub-module 322 strategy. If the number of number of hunting actions is greater that the user-specified input number, as shown at decision block 324 in FIG. 3, then preference is given to the control actions as decided by sub-module 325, wherein the CAAS strategy provided by Sub-module 320 is given preference over the strategy decided by CADS Sub-module 321 with the control actions generated and displayed via module 223. If the number of number of hunting actions is less than the user-specified input number, then the CADS 321 strategy is incorporated at stage 326 in FIG. 3 with the information routed to both the Voltage Stability Monitoring Sub-Module 314 and the Control Resource Status Information Sub-module 315. A list of the set of effective control actions, via the Control Action Generation & Display Module 223, are thereafter displayed. This beneficial scheme ensures that a minimum number of controllers are employed in the RT-VSMAC Tool 210 to restore stability in the system of which gets displayed by module 223.

As this mode involves comprehensive mathematical computations running iteratively, there may additionally be some situations in which the time step of this mode might exceed the SE 202 time step, depending on the rate at which the SE 202 output is updated. There may also be certain situations when the system is highly stressed and needs to be relieved by immediate control actions without any appreciable time delay. For both these cases, the RT-VSMAC Tool 210 switches to the other controller mode i.e. the voltage stability controller mode—emergency mode 400, as detailed in the discussion for FIG. 4 that follows.

### Voltage Stability Controller—Emergency Mode:

FIG. 4 thus shows an example non-limiting flowchart of the Voltage Stability Controller Emergency Mode 400 of operation, as exemplified in the RT-VSMAC Tool 210 of FIG. 2. The aim here is to generate multiple sets of control actions in time critical fast steps, one set at a time based on measurement based feedback from SE 202 to improve the stability of the power system 100, as shown in FIG. 2. While not explicitly shown in FIG. 4, it is to be noted that similar to the discussion for the Normal Mode of operation discussion for FIG. 3, outputs from the Voltage Stability Monitoring Sub-module 214 and the Control Resource Status Information Sub-module 215, as is shown in FIG. 2, are provided to a decision stage 416 of FIG. 4.

At each step, the emergency mode strategizes and generates the different types of coordinated wide area control actions in a substantially non-iterative manner, thus involving minimal computational time. While performing the control strategies at each internal stage, this mode takes into account the coordinated decisions made by the Control Action Activation Strategizing (CAAS) Sub-module 420 and/or Control Action Deactivation Strategizing (CADS) Sub-module 421 along with the Hunting Action Detection (HAD) Sub-module 422. If the Real Time Voltage Stability Monitoring Engine does not detect one or more buses violating the set VSAI alarm limit, as indicated by decision block 416 (216 in FIG. 2), then a decision at stage 419 is made to decide if any Type-I controls, as discussed in detail above, are still on. If any Type-1 controls are not on, then this is displayed via module 224. If Type-1 controls are still on because at least one bus or buses has exceeded the user-defined VSAI alarm threshold, then the Control Action Deactivation Strategizing (CADS) Sub-module 421 is enabled with its output provided to the Hunting Action Detection (HAD) Sub-module 422 (shown as module 322 in FIG. 3), as discussed above.

The individual roles of these sub-modules remain exactly the same as that in the voltage stability controller—normal mode, as discussed above. Because the emergency mode 400 strategizes control action set for each step based on feedback from the SE 202 at the beginning of that step, hence even though this mode doesn't pre-estimate the effects of strategized control actions like the ‘Normal Mode’ 300, this mode is still inherently self-corrective in nature. Thus, if one or more control actions do not actually improve the system voltage stability, the CADS Sub-module 421, as shown in FIG. 4, of this mode can automatically deactivate such controls at a later step. At each stage, these sets of control instructions will be displayed in 224.

Although, this mode of operation (i.e., Emergency Mode 400) has the capability of strategizing necessary control actions very quickly, as mentioned above, when operated in this mode, more number of control actions are eventually required to improve the system voltage stability as compared to just one set of control actions required by the ‘Normal Mode’ 300. Thus, the tradeoff between the two alternative modes are either at the discretion of the system operator, who can decide when to give precedence to the ‘Emergency Mode’ 400 over ‘Normal Mode’ 300 based on VSAI alarm settings, or are automatically decided based on the update rate of SE 202 output.

All the sets of control actions planned by both the modes of the Voltage Stability Controller—Normal Mode 300 & Emergency Mode 400 can be broadly categorized as local control, i.e., control actions taken using devices present at the identified weak buses by the real time voltage stability monitoring engine, and remote control i.e. control actions taken using devices present at selected buses which are most effective in improving the voltage stability at the weak buses. Selection of buses for remote control is decided using sensitivity analysis and graph-theoretic analysis, taking care of cost functions.

A matrix known as Remote Bus Selection Index Matrix (RBSIM) is computed as follows using Equation 1 shown below:

$$[ RBSIM ] = Index \{ \frac{[ \frac{d V}{d Q} ]}{[ Shortest Electrical Distance ]} \} \\ where \text{:} [ \frac{d V}{d Q} ] = {\{ - 1 \times \vert {V}_{i} \vert \times \vert {V}_{j} \vert \times \vert {Y}_{{Bus}_{ij}} \vert \times sin ( {θ}_{ij} + {δ}_{j} - {δ}_{i} ) \}}^{- 1} ; \\ for \\ i \neq j = {\{ \begin{matrix}- 2 \times {\vert {V}_{i} \vert}^{2} \times imaginary ( {Y}_{{Bus}_{ij}} ) - \\ ( - {Q}_{j} ) - {\vert {V}_{i} \vert}^{2} \times imaginary ( {Y}_{{Bus}_{ij}} )\end{matrix} \}}^{- 1} ; \\ for i = j \qquad ( 1 )$$

The [Shortest Electrical Distance] utilized in Equation 1 above involves a Matrix beneficial algorithm to find all pairs of the shortest path, where the buses form nodes of the graph, while edge weights can be determined by either one or all or a combination of the following based on user preference—line impedance, cost functions of executing different control actions involved in Type-1 and Type-2 categories from different buses in the power system, and/or power losses. The algorithm can also often, but not necessarily include an algorithm that utilizes a method of finding the shortest path(s) between all pairs of nodes in a sparse, branch (edge) weighted, directed graph. Such an example method allows some of the branch weights to be negative numbers, but no negative-weight cycles may exist and works by using a computed transformation of an input graph that removes all negative weights, allowing the algorithm disclosed herein to be used on the transformed graph.

The elements of the Remote Bus Selection Index Matrix (RBSIM), as computed from Equation (1) shown above, can thus be used, if desired, to rank the buses for remote voltage stability control. The higher the value of the RBSIM, the higher the priority the corresponding remote bus gets for activation of Type-1 and Type-2 control actions than the other buses. As part of the process, while deactivation of the Type-1 control actions, an alternative example embodiment includes the buses with lower values of RBSIM gets the higher priority.

The coordination amongst the different control devices for their activation for voltage stability control are then planned by CAAS Sub-module using hierarchical prioritization, as shown in Table 1 below:

TABLE 1
Priority for activation of coordinated control actions (if available)

| Priority | Activation of Control Actions | Method of Activation |
|---|---|---|
| 1 | Local Line Switching (Type-1) - Line | All at a time |
| | connected directly to a weak bus | |
| 2 | Remote Line Switching (Type-1) - Line | All at a time |
| | connected to the bus directly connected to a | |
| | weak bus | |
| 3 | (a) Transformer Automatic Load Tap | All at a time |
| | Changer Blocking (Type-1) Transformer | |
| | directly connected to a weak bus | |
| | (b) Series Q-Compensation (Type-1) - | All at a time |
| | Series Capacitor directly connected to a | |
| | weak bus | |
| | (c) Local Shunt Q-compensation (Type-1) - | All weak buses at a time, |
| | Capacitor banks to be added directly to a | starting with the lowest |
| | weak bus | available capacity of |
| | | capacitor bank at each time |
| 4 | Remote Shunt Q-compensation (Type-1) - | All buses at a time based |
| | Capacitor banks added to a bus directly | on RBSIM value, starting |
| | connected to a weak bus | with the lowest available |
| | | capacity of capacitor bank |
| | | at each time |
| 5 | (a) Remote Generator Q-compensation | One bus at a time based on |
| | (Type-1) - Generator located electrically | RBSIM value |
| | closest to a weak bus | Q_{G} = √[(1 − P_{G}²/P_{M}²) × |
| | | Q_{M}²] → Generator |
| | | Capability Curve Equation |
| | (b) Remote Synchronous Condenser | One bus at a time based on |
| | Q-compensation (Type-1) - Synchronous | RBSIM value |
| | Condenser located electrically closest to a | |
| | weak bus | |
| 6 | Local Load-shedding (Type-2) - Load shed | All weak buses at a time, |
| | at the weak bus | starting with the lowest |
| | | priority load |
| 7 | Remote Load-shedding (Type-2) - Load | All buses at a time based |
| | shed at a bus directly connected to a weak bus | on RBSIM value, starting |
| | | with the lowest priority load |

The coordination amongst the different control devices for their deactivation are planned by CADS Sub-module as shown in Table 2 below:

TABLE 2
Deactivation of coordinated control actions in Type-1 category

| Deactivation of Control Actions | Method of Deactivation |
|---|---|
| Local & Remote Line Switching | One at a time, starting |
| | with bus with lower VSAI |
| Transformer Automatic Load Tap | All at a time |
| Changer Blocking | |
| Series Q-Compensation | All at a time |
| Remote Generator Q-compensation | One at a time, based on |
| | RBSIM value |
| Remote Synchronous Condenser | One at a time, based on |
| Q-compensation | RBSIM value |
| Remote Shunt Q-compensation | One at a time, based on |
| | RBSIM value (lower |
| | capacities of capacitor |
| | banks are deactivated first) |
| Local Shunt Q-compensation | One at a time, starting |
| | with bus with lower VSAI |
| | (lower capacities of |
| | capacitor banks are |
| | deactivated first) |

The present invention will be more fully understood by reference to the following results, which are intended to be illustrative of the present invention, but not limiting thereof.

### Experimental Results:

The RT-VSMAC Tool performance has been validated by simulation for IEEE test cases under different conditions of deteriorating voltage stability condition. Following modifications have been done in the Standard IEEE test cases to include the following control devices for improving voltage stability of the system:
Introduction of LTC Transformer at some load buses.
Introduction of switched series capacitors in some of the lines connecting to some load buses. The series capacitors have been chosen in such a way that they reduce the effective line reactance by 10% of their original values.
Introduction of one or more switched shunt capacitor banks at some load buses. The range of shunt capacitor banks introduced varies from 0.5 MVAR to 2 MVAR.

The above modifications have been done to demonstrate the effect of these control devices used in a coordinated manner by the RT-VSMAC Tool.

Test Case-1: Voltage Stability Monitoring & Control using RT-VSMAC Tool for modified IEEE-30 Bus System

Table-3 below shows the sequence of events taking place in the modified IEEE-30 test system leading to the weakening of a part of the system from voltage stability perspective.

TABLE 3
Events leading to reduced voltage stability
margin of IEEE 30 Bus test case

| Stage | Description of the Event |
|---|---|
| 1 | System is at Base Case |
| 2 | Increase in loading at Bus-19 by 20% of its base case value |
| 3 | Increase in loading at Bus-21 by 20% of its base case value |
| 4 | Increase in loading at Bus-24 by 20% of its base case value |
| 5 | Increase in loading at Bus-30 by 20% of its base case value |
| 6 | Increase in loading at Bus-30 by 100% of its base case value |
| 7 | Increased overloading of Bus-30 results in tripping of the |
| | Line-27-30 by the relay monitoring that line |

After the 7th stage, the real time voltage stability monitoring engine of the RT-VSMAC Tool can, as part of the process, indicate that a VSAI bus, e.g., Bus-30 as shown in Table-3, has exceeded the user-defined limit. As a non-limiting example, a VSAI user defined limit of 0.7 can be provided for one or more buses to include Bus-30, and if, for example the VSAI of Bus-30 exceeds that threshold value, such as, by indicating a VSAI of 0.8614, then an overloading condition exists for Bus-30 in this example scenario. For such an example case, the settings of the RT-VSMAC Tool 210 can as an example embodiment, be configured such that the Voltage Stability Controller—Normal Mode 300 always gets preference and thus in such a configuration can overwrite the decisions of the Voltage Stability Controller—Emergency Mode 400. Often, but not necessarily, this happens if the time step of the Normal Mode 300 is less than that of the SE 202, as shown in FIG. 2, feeding data into the RT-VSMAC Tool 210 or if the system is still at a safe distance from the Point of Collapse (PoC) and doesn't need immediate control actions (i.e. without any appreciable time delay).

Table 4 below shows the set of control actions that can be provided by the Normal Mode 300 of the RT-VSMAC Tool 210 to the operator to improve the system voltage stability condition in one step (e.g., after Stage-7 in Table-3).

TABLE 4
Control actions by the Voltage Stability Controller - Normal
Mode of RT-VSMAC Tool for improving voltage
stability margin of IEEE 30 Bus test case

| | Sr. | |
|---|---|---|
| Stage | No. | Control Actions |
| 8 | 1 | Shunt Capacitor Bank-1 rated 0.50 MVAR at Bus-29 needs |
| | | to be switched ON |
| | 2 | Shunt Capacitor Bank-2 rated 1 MVAR at Bus-29 needs to |
| | | be switched ON |
| | 3 | Shunt Capacitor Bank-1 rated 1 MVAR at Bus-30 needs to |
| | | be switched ON |
| | 4 | Shunt Capacitor Bank-2 rated 1 MVAR at Bus-30 needs to |
| | | be switched ON |
| | 5 | Shunt Capacitor Bank-3 rated 1 MVAR at Bus-30 needs to |
| | | be switched ON |
| | 6 | Shunt Capacitor Bank-4 rated 1.5 MVAR at Bus-30 needs |
| | | to be switched ON |
| | 7 | Series Capacitor in the Line 29-30 needs to be switched |
| | | ON |
| | 8 | Load-shedding needs to be performed at Bus-30 such that - |
| | | [a] Real Power Load to be shed = 2.65 MW |
| | | [b] Reactive Power Load to be shed = 0.475 MVAR |

Such example control actions are thus capable of being displayed by the RT-VSMAC Tool 210 either singularly, or in combinations or more often all at once for the system operator to act on. If advanced communication infrastructure is available in a smart grid environment, then all these control actions can be implemented automatically (such as but not limited to, an automated closed loop) to the circuit breakers in the system associated with these controls.

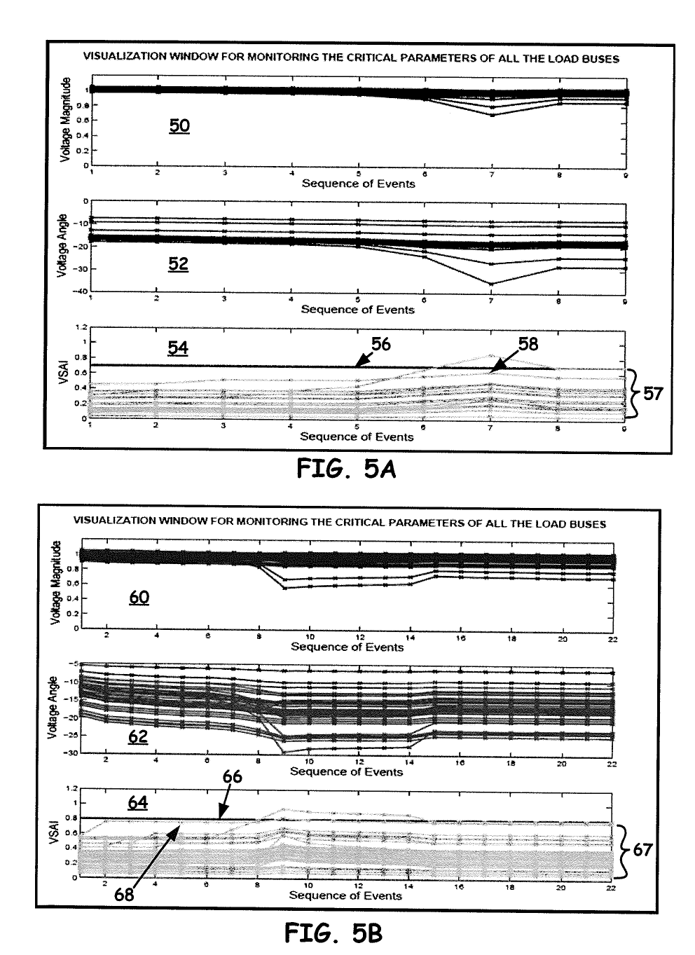

FIG. 5A shows an illustrative view of critical parameters (voltage magnitude 50 & angle 52) and of VSAI 54 of all load buses in an example test power system. Such plots are thus illustrative of starting from the base case (e.g., below the defined VSAI threshold) till it gets stressed (due to a given sequence of events, such as the example events disclosed in Table-3). From such events, the results desirably induce being controlled by the RT-VSMAC Tool 210, as disclosed herein, e.g., in the form of the control actions listed in Table-4.

It can thus be seen from FIG. 5A that after a desired set of control actions are generated, such as the example control actions shown in Table 4, the VSAI (as denoted by reference numeral 57) of the buses more often result in falling below the set VSAI alarm limit, such as the exemplary 0.7 limit as denoted by reference numeral 56 shown in the bottom plot of FIG. 5A, with the weakest Bus in the system. e.g., Bus-30, resulting in a desirable VSAI of 0.6959, as denoted by reference numeral 58. As the system VSAI is given by the VSAI of the weakest bus in that system, such illustrative plots indicate that the Voltage Stability Controller—Normal Mode 300 of the present application succeeded in bringing the system VSAI to its desired value.

Test Case-2: Voltage Stability Monitoring & Control using RT-VSMAC Tool for modified IEEE-57 Bus System

Table 5 below shows the sequence of events taking place in the modified IEEE-57 test system leading to the weakening of a part of the system from voltage stability perspective.

TABLE 5
Events leading to reduced voltage stability
margin of IEEE 57 Bus test case

| Stage | Description of the Event |
|---|---|
| 1 | System is at Base Case |
| 2 | Increase in loading at Bus-47 by 100% of its base case value |
| 3 | Increase in loading at Bus-49 by 50% of its base case value |
| 4 | Increase in loading at Bus-50 by 50% of its base case value |
| 5 | Increase in loading at Bus-51 by 50% of its base case value |
| 6 | Increase in loading at Bus-52 by 50% of its base case value |
| 7 | Increase in loading at Bus-53 by 50% of its base case value |
| 8 | Increase in loading at Bus-53 by 150% of its base case value |
| 9 | Increased overloading of Bus-53 results in tripping of the |
| | Line-53-54 by the relay monitoring that line |

In this illustrative example, after the 9th stage, the real time voltage stability monitoring engine of the RT-VSMAC Tool 210 now can indicate that a plurality of VSAI buses, e.g., Bus-53 and Bus-47, have exceeded the user-defined threshold, similar to that for the discussion of Bus-30 above. In this illustrative example result, the VSAI of Bus-53 has risen to 0.9379 (not detailed) and the VSAI of Bus-47 is now at 0.8144 (not detailed), both of which exceed the user-defined VSAI alarm limit of, for this example scenario, 0.8. In such a scenario, the functioning of the Voltage Stability Controller—Emergency Mode 400 is beneficially enabled by configuring the settings of the RT-VSMAC Tool 210 such that the Voltage Stability Controller—Emergency Mode 400 always get preference and overwrites the decisions of the Voltage Stability Controller—Normal Mode 300. Such a beneficial process happens if the time step of the Normal Mode 300 is higher than that of the SE feeding data into the RT-VSMAC Tool 210 or if the system is not at a safe distance from the Point of Collapse (PoC) and thus needs immediate control actions (i.e. without any appreciable time delay). Table-6 shows the sets of control actions suggested by the Emergency Mode 400 of the RT-VSMAC Tool 210 to the operator to improve the system voltage stability condition in multiple steps (after, for example, Stage-9 in Table-5).

TABLE 6
Control actions by the Voltage Stability Controller - Emergency
Mode of RT- VSMAC Tool for improving voltage
stability margin of IEEE 30 Bus test case

| | Sr. | |
|---|---|---|
| Stage | No. | Control Actions |
| 10 | 1 | Transformer Automatic Load Tap Changer is blocked |
| | | at Bus-47 |
| | 2 | Shunt Capacitor Bank-1 rated 1 MVAR at Bus-47 needs to |
| | | be switched ON |
| | 3 | Shunt Capacitor Bank-1 rated 1 MVAR at Bus-53 needs to |
| | | be switched ON |
| | 4 | Series Capacitor in the Line 46-47 needs to be switched |
| | | ON |
| | 5 | Series Capacitor in the Line 47-48 needs to be switched |
| | | ON |
| | 6 | Series Capacitor in the Line 52-53 needs to be switched |
| | | ON |
| 11 | 1 | Transformer Automatic Load Tap Changer is unblocked at |
| | | Bus-47 |
| | 2 | Shunt Capacitor Bank-2 rated 1.5 MVAR at Bus-53 needs |
| | | to be switched ON |
| | 3 | Series Capacitor in the Line 46-47 needs to be switched |
| | | OFF |
| | 4 | Series Capacitor in the Line 47-48 needs to be switched |
| | | ON |
| 12 | 1 | Shunt Capacitor Bank-3 rated 1.5 MVAR at Bus-53 needs |
| | | to be switched ON |
| 13 | 1 | Shunt Capacitor Bank-1 rated 1 MVAR at Bus-52 needs to |
| | | be switched ON |
| 14 | 1 | Shunt Capacitor Bank-2 rated 2 MVAR at Bus-52 needs to |
| | | be switched ON |
| 15 | 1 | Load-shedding needs to be performed at Bus-53 such that - |
| | | [a] Real Power Load to be shed = 7.5 MW |
| | | [b] Reactive Power Load to be shed = 3.75 MVAR |
| 16 | 1 | Series Capacitor in the Line 52-53 needs to be switched |
| | | OFF |
| | 2 | Shunt Capacitor Bank-1 rated 1 MVAR at Bus-52 needs to |
| | | be switched OFF |
| 17 | 1 | Shunt Capacitor Bank-2 rated 2 MVAR at Bus-52 needs to |
| | | be switched OFF |
| 18 | 1 | Shunt Capacitor Bank-1 rated 1 MVAR at Bus-47 needs to |
| | | be switched OFF |
| 19 | 1 | Shunt Capacitor Bank-1 rated 1 MVAR at Bus-53 needs to |
| | | be switched OFF |
| 20 | 1 | Shunt Capacitor Bank-2 rated 1.5 MVAR at Bus-53 needs |
| | | to be switched OFF |
| 21 | 1 | Shunt Capacitor Bank-3 rated 1.5 MVAR at Bus-53 needs |
| | | to be switched OFF |

One or more, but often all of the above example listed control actions are displayed by the RT-VSMAC Tool 210 at more often every stage, without any appreciable time delay from the time the SE data is input to the RT-VSMAC Tool for the system operator to act on immediately. If advanced communication infrastructure is available in a smart grid environment, then all these control actions can be generated automatically (again, such as, but not limited to, in an automated closed loop) to the circuit breakers in the system associated with these controls.

FIG. 5B shows resultant plots of the critical parameters (voltage magnitude 60 & angle 62) and with the VSAI 64 of all load buses in the test power system, starting from the base case (not shown) till it gets stressed (due to, for example, a sequence of events such as that shown in Table-5). Control is then capable of being enabled by the RT-VSMAC Tool 210 (in the form of the control actions listed in example Table-6).

It can be seen that after sets of control actions (e.g., such as that mentioned in Table-6) are generated, the VSAI of the buses (as denoted by reference numeral 67) are again brought down below the set VSAI alarm limit, e.g., 0.8 (as denoted by reference numeral 66), with the weakest Bus in the system being, in this example, Bus-53 (as denoted by reference numeral 68) having a VSAI of 0.7906. As the system VSAI is given by the VSAI of the weakest bus in that system, it can be safely concluded that the Voltage Stability Controller—Emergency Mode 400 is successful in bringing the system VSAI to its desired value. It is worth mentioning here that, even though the number of control action sets in this mode of operation seems to be large due to increased number of stages (as opposed to only one stage required for the Normal Mode 300), the decision of coordinated control action sets in each stage is made much quicker in this mode (it being completely non-iterative) as compared to a small time delay in case of the Normal Mode 300. However in reality, it is highly likely that after the first couple of stages of Emergency Mode of operation, the VSAI of the weak bus (or buses) in the system might come down to the extent that the RT-VSMAC Tool 210 would automatically switch back to the Normal Mode 300 of operation, which would then just need one more set of control actions (in another stage) to bring the system VSAI to the desired value.

It is to be understood that features described with regard to the various embodiments herein may be mixed and matched in any combination without departing from the spirit and scope of the invention. Although different selected embodiments have been illustrated and described in detail, it is to be appreciated that they are exemplary, and that a variety of substitutions and alterations are possible without departing from the spirit and scope of the present invention.

1. A method for real time control of voltage stability in a power system;
comprising:
with a logic processor device,
estimating system parameters based on one or more received data sets of system parameters of a power system, wherein the one or more received data sets of system parameters further comprises at least one of: a voltage magnitude and a voltage angle and breaker ON/OFF status of switch at each bus in the power system;
non-iteratively determining a voltage stability index for each bus in the power system based on the estimated system parameters and the received one or more data sets of system parameters;
comparing the determined voltage stability index for each bus to a predetermined voltage stability index threshold; and
activating a voltage stability control mode resultant from the comparison of the computed voltage stability index for each bus to the predetermined voltage stability index threshold, wherein activating a voltage stability control mode includes at least one mode selected from:
a normal voltage stability control mode of operation and an emergency voltage stability control mode of operation of operation.

2. The method of claim 1, wherein activating the normal voltage stability control mode further comprises:
determining if any of the buses exceeds the predetermined voltage stability index threshold;
strategizing one or more types of coordinated wide area control actions if any of the buses have exceeded the predetermined voltage stability index threshold;
estimating effects of the one or more types of coordinated wide area control actions at each internal stage using an internal voltage stability controller module; and
activating via a control action activating sub-module (CAAS), a set of effective control actions based on the estimating effects.

3. The method of claim 2, wherein activating the normal voltage stability control mode further comprises:
determining if any of the one or more predetermined wide area control actions are enabled resultant from any of the buses that do not exceed the predetermined voltage stability index threshold;
deactivating via a control action deactivating sub-module (CADS), one or more of the predetermined controls that have been previously activated that are in excess of what is required.

4. The method of claim 3, wherein activating a normal voltage stability control mode further comprises:
hunting between the actions of the control action activating submodule (CAAS) and the control action deactivating submodule (CADS);
providing a user-specified input to determine a number of hunting actions;
preferring control to the control action activating submodule (CAAS) based on the user-specified input that determines the number of hunting actions; and
displaying a list of a set of effective control actions.

5. The method of claim 2, wherein the one or more types of coordinated wide area control actions further comprises at least one type of control selected from: line switching, transformer automatic load tap changer blocking, shunt reactive power compensation, series reactive power compensation, generator and synchronous condenser reactive power control, and controlled load priority.

6. The method of claim 1, wherein activating an emergency voltage stability control mode further comprises:
automatically switching to the emergency mode of voltage stability operation based on an estimated system parameter update rate requiring immediate control actions;
determining if any of the buses exceeds the predetermined voltage stability index threshold;
strategizing one or more types of coordinated wide area control actions if any of the buses have exceeded the predetermined voltage stability index threshold;
non-iteratively activating via a control action activating sub-module (CAAS), a set of effective
control actions based on the estimating effects; and
displaying the set of effective control actions that are to be generated.

7. The method of claim 6, wherein activating the emergency voltage stability control mode of operation further comprises:
determining if any of one or more predetermined wide area control actions are enabled resultant from any of the buses that do not exceed the predetermined voltage stability index threshold;
deactivating via a control action deactivating sub-module (CADS), one or more of the predetermined controls that have been previously activated that are in excess of what is required; and
displaying a set of one or more of the deactivating predetermined controls provided by the CADS sub-module.

8. The method of claim 6, wherein activating the emergency voltage stability control mode of operation further comprises:
hunting between the actions of the control action activating submodule (CAAS) and the control action deactivating submodule (CADS);
providing a user-specified input to determine a number of hunting actions; and
preferring control to the control action activating submodule (CAAS) based on the user-specified input that determines the number of hunting actions.

9. The method of claim 7, wherein the one or more types of coordinated wide area control actions further comprises at least one type of control selected from: line switching, transformer automatic load tap changer blocking, shunt reactive power compensation, series reactive power compensation, generator and synchronous condenser reactive power control, and controlled load priority.

10. The method of claim 6, wherein activating an emergency voltage stability control mode further comprises:
manually deciding on the emergency mode of operation based on voltage stability index settings.

11. The method of claim 1, wherein monitoring the voltage stability index threshold further comprises:
determining if any of the buses exceeds the predetermined voltage stability index threshold;
requesting a new data set of system parameters if none of the buses exceeds the predetermined voltage stability index threshold; and
archiving a new data set of system parameters if one or more of the buses does exceed the predetermined voltage stability index threshold so as to provide a status of on 2 or more control devices/equipment disposed in the monitored power system.

12. The method of claim 11, wherein the archiving step to provide a status of one or more control devices/equipment in the monitored power system further comprises:
determining a status of at least one of the control devices/equipment selected from: line switching capability, transformer automatic load tap changer blocking availability, series reactive power compensation availability, generator and synchronous condenser reactive power control availability, and load priority.

13. The method of claim 6, wherein activating the emergency voltage stability control mode of operation further comprises:
automatically switching back to the normal voltage stability control mode of operation if one or more of the detected buses that were above the determined voltage stability index threshold now registers a desired value below the voltage stability index threshold after two or more stages of evaluation.

14. The method of claim 1, wherein the comparing step in determining the voltage stability index for each bus further comprises:
utilizing a Remote Bus Selection Index Matrix (RBSIM) to rank the buses for remote voltage stability control.

15. The method of claim 13, wherein the Remote Bus Selection Index Matrix (RBSIM) is computed using a Johnson's algorithm.

16. A real time voltage stability index computing system, comprising:
a logic processor device;
a memory operatively coupled to the processor, the memory containing instructions that when executed by the processor cause the logic processor device to perform a process including:
estimating system parameters based on one or more received data sets of system parameters of a power system, wherein the one or more received data sets of system parameters further comprises at least one of: a voltage magnitude and a voltage angle and breaker ON/OFF status of switch at each bus in the power system;
non-iteratively determining a voltage stability index for each bus in the power system based on the estimated system parameters and the received one or more data sets of system parameters;
comparing the determined voltage stability index for each bus to a predetermined voltage stability index threshold; and
activating a voltage stability control mode resultant from the comparison of the computed voltage stability index for each bus to the predetermined voltage stability index threshold, wherein activating a voltage stability control mode includes at least one mode selected from: a normal voltage stability control mode of operation and an emergency voltage stability control mode of operation of operation.
